(19) United States
(12) Patent Application Publication
(10) Pub. No.: US 2010/0248203 A1
(43) Pub. Date: Sep. 30, 2010

(54) Portable LED interactive learning device

(76) Inventors: Kuo Hsiing Cho, Zhubei City (TW); Ping Hung Tsai, Hsinchu City (TW); Chin-I Liu, Houli Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/382,879

(22) Filed: Mar. 26, 2009

(51) Int. Cl. G09B 5/00

(52) U.S. Cl. 434/308; 434/428

(57) ABSTRACT

The present invention discloses a portable LED interactive learning device for generating a series of displays to underage kids and method thereof. The portable LED interactive learning device in the present invention includes a motion detecting device, a tilt detecting device, a micro processer, and a LED set. The portable LED interactive learning device can detect the user's motion and demonstrate a corresponding figure on the LED set. The user can further select the function of playing game or drawing chart based on the memory capacity of the present invention. By using LED display system, the present invention can provide a comparable lower price device for kid's learning development.

### BACKGROUND OF THE INVENTION

1. Field of the Invention

The invention relates to an interactive device, and more particularly, to a portable LED interactive learning and gaming device for generating a series of displays to underage kids and method thereof.

2. Description of the Related Art

Along with the vigorous development of electrical device and motion detecting technology, the interactive device focus on teenager education and learning purpose has been intensively investigated for various applications, such as video game console, electrical book or paper, and touch panel learning system. The advantages of using interactive device for education lie in the immediate reaction and colorful display to effectively attract our kids. With the accelerated development of underage learning system, efficient and cost effective methods of generating and displaying game or learning contents are of utmost importance.

However, the recent interactive device remains a major challenge in cost issue. For example, the use of the liquid crystal display (LCD) monitor or interactive touch panel system will dramatically increase the total cost of interactive learning device, which leave those devices unaffordable.

Therefore, to solve the above-mentioned problems, the present invention proposes a novel interactive learning device and method thereof for generating a series of displays by motion detection, which apples light emitting diode (LED) display and the motion detector into the structure of the interactive device to dramatically reduce the total cost of the underage learning device.

### SUMMARY OF THE INVENTION

It is therefore one of the many objectives of the claimed invention to provide a portable LED interactive learning device for generating series of displays by utilizing motion detecting device and LED set display to dramatically reduce the total cost of the underage learning device.

According to the claimed invention, a portable LED interactive learning device is disclosed. The portable LED interactive learning device includes: a motion detecting device for detecting a movement of a user and generating a motion signal based on said movement; a tilting detecting device for detecting a tilt condition for said portable LED interactive learning device and generating a tilt signal base on said tilt condition; a micro processor, coupled to said motion detecting device and said tilting detecting device, for receiving said motion signal and said tilt signal, and generating a corresponding display signal base on said motion signal and said tilt signal; and a LED set, coupled to said micro processor, for receiving said display signal, and displaying a figure corresponding to said display signal. The user can slightly touch or sweep finger above the detecting device to manipulate the device on the LED set. Moreover, the portable LED interactive learning device in the present invention utilizes LED set in the present invention can significantly reduces the display cost, and creates more convenience and affordable device for kid's education development.

Below, the embodiments of the present invention are described in detail in cooperation with the attached drawings to make easily understood the objectives, technical contents, characteristics and accomplishments of the present invention.

### BRIEF DESCRIPTION OF THE DRAWINGS

FIG. 1 is a block diagram of a portable LED interactive learning device according to an embodiment of the present invention.

FIG. 2 is a block diagram of the motion detecting device according to an embodiment of the present invention.

FIG. 3 is a flowchart showing an operation of a portable LED interactive learning device according to an embodiment of the present invention.

FIG. 4 is diagram schematically showing a deployment of portable LED interactive learning device according to an embodiment of the present invention.

FIG. 5 is diagram schematically showing another deployment of portable LED interactive learning device according to an embodiment of the present invention.

FIG. 6 is diagram schematically showing an embodiment of portable LED interactive learning device association with real time clock or alarm, clock of the present invention.

### DETAILED DESCRIPTION OF THE INVENTION

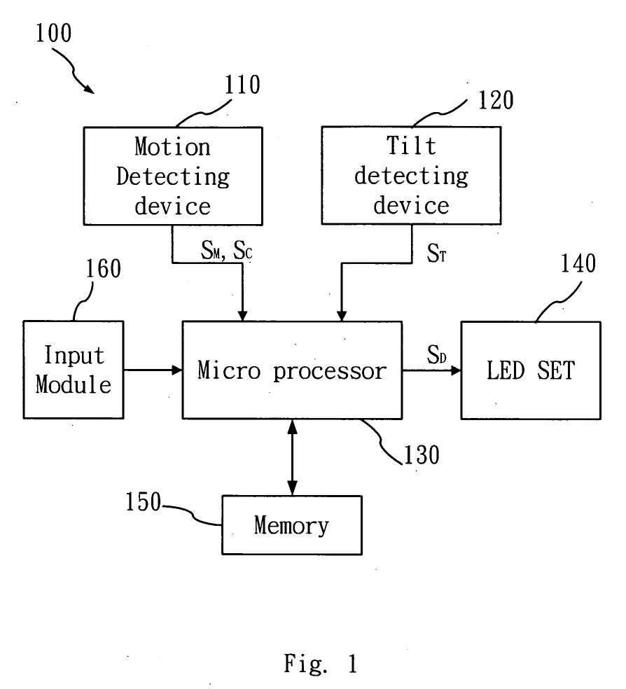

Please refer to FIG. 1. FIG. 1 is a block diagram of a portable LED interactive learning device according to an embodiment of the present invention. The portable LED interactive learning device 100 in the present invention includes a motion detecting device 110, a tilt detecting device 120, a micro processer 130, a LED set 140, a memory 150, and a input module 160. The motion detecting device 110 and the tilt detecting device 120 are utilized for detecting and receiving the user's motion control or order. The micro processer 130 will receive the control signals from both the motion detecting device 110 and the tilt detecting device 120, and send a display signal to the LED set 140 based on the user's motion. The LED set 140 is utilized for displaying any learning or game contents according the display signal. The memory 150 can be utilized for storing the display and interactive record or the game contents. The input module 160 can receive outside input source, such as flash drive or hard disk, to extend the capacity of the memory 150. The fully operation of the portable LED interactive learning device 100 in the present invention is detailed as follows.

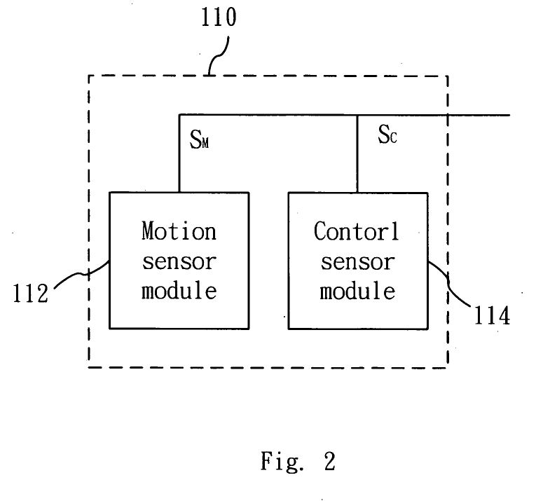

First, the motion detecting device 110 will detect any motion or action derived from the user's gesture. Please refer to FIG. 2. FIG. 2 is a block diagram of the motion detecting device 110 according to an embodiment of the present invention. The motion detecting device 110 further includes a motion sensor 112 and a control sensor module 114. The motion sensor 112 is utilized for detecting the user's gesture. For example, when the user sweeps his finger form right to left above the motion sensor 112 to draw a horizontal line, the motion sensor 112 will generate a motion signal S_{M} based on the user's sweep. The LED set 140, latter proceeds by the micro process 130, will display a corresponding horizontal line according to the motion signal S_{M}. Moreover, the control sensor module 114 is utilized as function selection controls. There are many types of function selections for game and learning purpose, such as store, reset, start, forward or backward. The user can setup the desire function at will. For instance, in one embodiment of the present invention, the user can setup an order by placing his finger above the control sensor module 114 for at least 3 seconds as a “store” function. And the control sensor module 114 will generate a corresponding control signal S_{C} based on the above motion order.

In practice, the motion sensor 112 and the control sensor module 114 can be implemented by infrared photography (IR) sensors, gyro sensors, phototransistors, photo-resistors or other photosensitive devices. And we are going to use IR sensors to illustrate the embodiment of the present invention. The IR sensors comprise a pair of IR photodiodes and IR emitters. The IR photodiodes and the IR emitters can be received and emitted at the same time. Therefore, the user only needs to slightly touch or sweep thumb above the IR sensors and the motion sensor 112 and the control sensor module 114 can be thereby enacted. The advantage of using IR sensors is that they are much cheaper than touch panels, and the user does not really need to push the buttons to manipulate the device and play games. However, as will be easily observed by a personal of ordinary skill in the art, other embodiments of the present disclosure utilizing different types of sensor devices are also possible, and the use of IR sensors is not meant to be taken as limitations.

Next, the tilt detecting device 120 is utilized for detecting tilt condition of the device and generating a tile signal S_{T} based on the tilt condition. Similar as the control sensor module 114, the tilt detecting device 120 in the present invention can be utilized as function selection controls, such as a navigation function. For example, if the user wants to see next figures, they can tilt the device forward and backward to see the previous figures. Moreover, the tilt detecting device 120 can also be used to detect the shake movement of the device, which can create more movement selections for the user to control the interactive device in the present invention. In practice, the tilt detecting device 120 can be implemented by a jiggle switch, G-sensor or other tilting detecting units. Same, the use of the jiggle switch or G-sensor is not meant to be taken as limitations.

After receiving the motion signal S_{M}, the control signal S_{C}, or tilt signal S_{T} from the motion sensor 112, the control sensor module 114, or the tilt detecting device 120, the micro processor will proceed these signals and generate a display signal S_{D} to LED set 140 to display corresponding figures. In one embodiment of the present invention, the LED set 140 is consisting of 108 LEDs to form a 5″ display matrix. Please note that, the present invention id not limited to the color selection of LEDs. That is, the LED set 140 can be embodied by different colors, such as red, green, or blue, depending on different design requirements. Comparing with other display device (e.g. LED display, OLED display, TFT LCD, OLED display or TN type LCD display), the usage of LEDs in the present invention thereby significantly reduces the display cost, which can create more convenience and affordable device for kid's education development.

The memory 150 can be utilized for storing the game contents or the user's interactive record. The input module 160 can receive outside input source, such as cartridge, flash drive, or hard disk, to provide more contents or games, and extend the capacity of the memory 150. Here, the input module 160 can be embodied by a cartridge slot, or a USB interface slot. Moreover, the portable LED interactive learning device 100 in the present invention can further include a build-in audio system (not shown) to play back the sound effect and music during the game playing, which can increase more interactive attraction for kids.

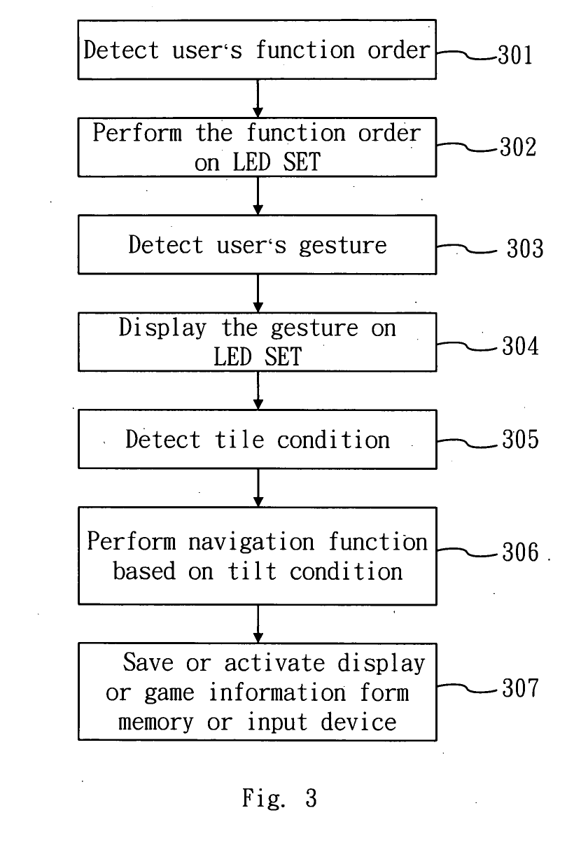

Please refer to FIG. 3. FIG. 3 is a flowchart showing an operation of a portable LED interactive learning device according to an embodiment of the present invention. Provided that substantially the same result is achieved, the steps of the flowchart shown in FIG. 3 need not be in the exact order shown and need not be contiguous, that is, other steps can be intermediate. As shown in FIG. 3, the user's function order (e.g. start, reset, or replay function) will be detected by the portable LED interactive learning device based user's motion (Step 301). After receiving the order from the motion detecting device, the micro processer will perform the function order on LED set based on the receiving order (Step 302). Next, user's gesture will be detected to determine the figure which the user desires to draw (Step 303). Then the figure will be display on the LED set based on the detected gesture (Step 304). Moreover, the tilt condition of the device will be detected by the tilt detecting device (Step 305), and the corresponding navigation function will be performed on LED set based on the receiving tilt condition (Step 306). Last, the playing information or game data can be saved and stored in the memory, or stored in outside memory devices through the input module (Step 307).

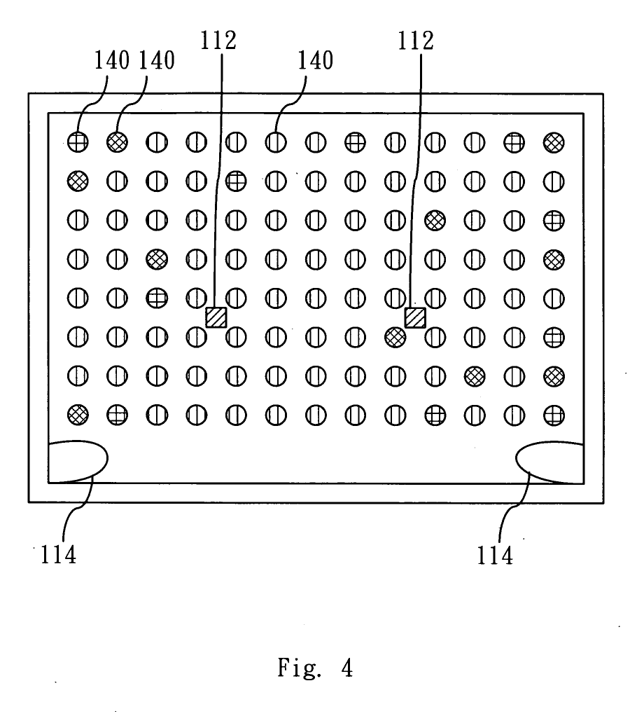

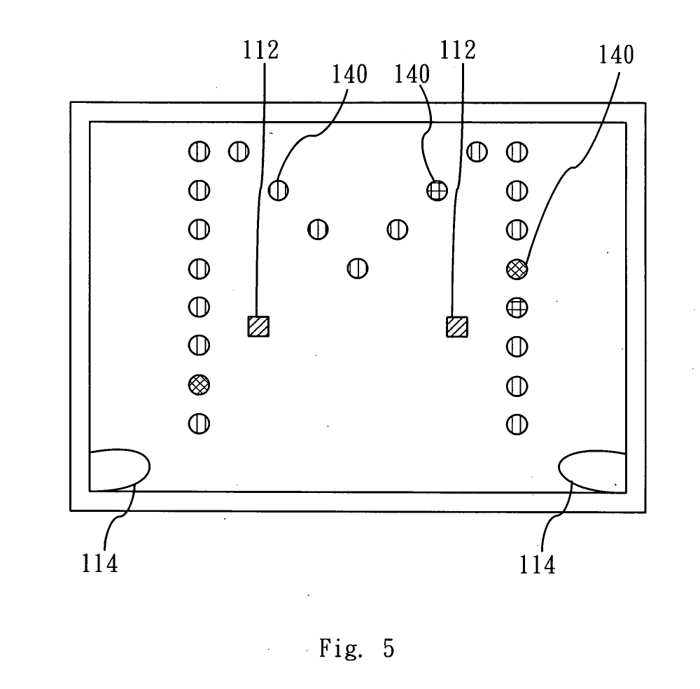

Please refer to FIG. 4 and FIG. 5, FIG. 4 is diagram schematically showing a deployment of portable LED interactive learning device according to an embodiment of the present invention. As shown in FIG. 4, the motion sensor 112 can be located in the middle of LED set matrix in order to detect the user's movement. And the control sensor module 114 can be located at the right and left bottom corners of the LED set matrix, which the user can use the control sensor easily. As shown in FIG. 5, the portable LED interactive learning device can display any figure or letter (as shown “M” letter in FIG. 5) based on the users movement. Along with the tilt detecting module, the portable LED interactive learning device can create more functional abilities for user's selection.

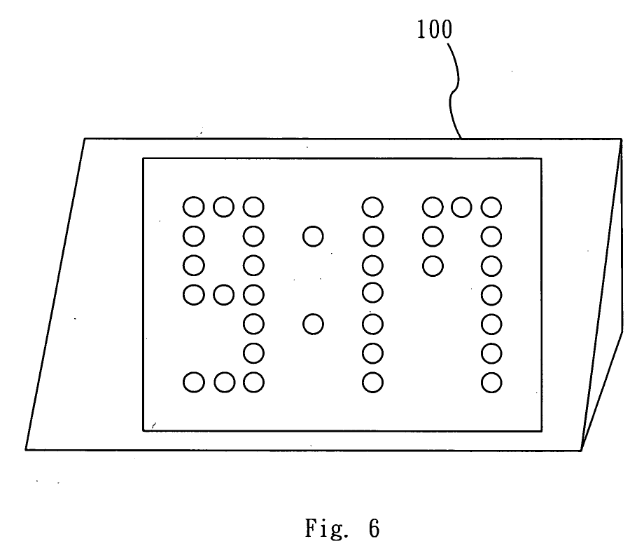

Another embodiment of the present invention is showing in FIG. 6. The portable LED interactive learning device can be association with real time clock or alarm clock. The user can be able to look at the real time through the portable LED interactive learning device 100 and to set the stand-up time. As shown in FIG. 6, the portable LED interactive learning device display the time 9:17, and when the real time clock or alarm clock rings, the user only needs to swing their hand a few times in front of the unit to shut off the ring. In contrast to the related art interactive device, the portable LED interactive learning device in the present invention utilizes sensor detectors to detect user's movement. The user does not really need to push any buttons to manipulate the device and play games. He only needs to slightly touch or sweep thumb above the detecting device to play on the screen. Moreover, the portable LED interactive learning device in the present invention utilizes LED set as a display mean, which significantly reduces the display cost, and creates more convenience and affordable device for kid's education development.

Those described above are only the preferred embodiments to exemplify the present invention but not to limit the scope of the present invention. Any equivalent modification or variation according to the shapes, structures, features and spirit disclosed in the specification is to be also included within the scope of the present invention.

What is claimed is:

1. A portable LED (light emitting diode) interactive learning device for educating underage kids, comprising:
a motion detecting device for detecting a movement of a user and generating a motion signal based on said movement;
a tilting detecting device for detecting a tilt condition for said portable LED interactive learning device and generating a tilt signal base on said tilt condition;
a micro processor, coupled to said motion detecting device and said tilting detecting device, for receiving said motion signal and said tilt signal, and generating a corresponding display signal base on said motion signal and said tilt signal; and
a LED set, coupled to said micro processor, for receiving said display signal, and displaying a figure corresponding to said display signal.

2. The portable LED interactive learning device of claim 1, further comprising:
a memory, coupled to said micro processor, for storing said displaying single, said motion signal and said tilt signal, wherein said micro processor writes or reads said displaying single, said motion signal, and said tilt signal based on a follow movement of said user.

3. The portable LED interactive learning device of claim 1, further comprising:
an input module, couple to said micro processor, for connecting an outside memory device and extending said memory's capacity.

4. The portable LED interactive learning device of claim 1, further comprising:
an audio system, coupled to said micro processor, for playing a sound effect or a music based on said movement of said user.

5. The portable LED interactive learning device of claim 1, wherein said motion detecting device further comprises:
a motion sensor module, coupled to said micro processor, for detecting a first motion for said movement of said user; and
a control sensor module, coupled to said micro processor, for detecting a second motion for said movement of said user,
wherein said first motion comprises vertical, horizontal, circular movement of said user for the purpose of drawing a chart on said LED set; and said second motion comprises long-term pressing movement of said user for the purpose of at least a first functional control of said LED set.

6. The portable LED interactive learning device of claim 1, wherein said tilting detecting device utilizes as a second functional control of said LED set.

7. The portable LED interactive learning device of claim 5, wherein said first functional control comprises functions of start, reset, renew, or stop.

8. The portable LED interactive learning device of claim 6, wherein said second functional control comprises functions of navigation, forward, or backward.

9. The portable LED interactive learning device of claim 1, wherein said LED set comprises at least a light emitting diode with at least one color.

10. The portable LED interactive learning device of claim 5, wherein said motion sensor module and said control sensor module implements by infrared photography (IR) sensor, gyro sensor, phototransistor, photo-resistor or photosensitive device.

11. The portable LED interactive learning device of claim 10, wherein said infrared photography (IR) sensor comprises a pair of IR photodiode and IR emitter.

12. The portable LED interactive learning device of claim 1, wherein said tilting detecting device implements by a jiggle switch or G-sensor.
